(19) United States
(12) Patent Application Publication
(10) Pub. No.: US 2026/0094873 A1
(43) Pub. Date: Apr. 2, 2026

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Sanghyung KIM, Yongin-si (KR); TAE HYON BAE, Yongin-si (KR); Harim LEE, Yongin-si (KR); Seunghyeon SON, Yongin-si (KR); Yeji YANG, Yongin-si (KR); SUNDAE KIM, Yongin-si (KR); CHEONSOO KIM, Yongin-si (KR); Sangheon LEE, Yongin-si (KR)

(21) Appl. No.: 19/208,241

(22) Filed: May 14, 2025

(30) Foreign Application Priority Data
Sep. 27, 2024 (KR) 10-2024-0131854

(51) Int. Cl. H01M 10/0569; H01M 4/02; H01M 4/525; H01M 4/583; H01M 10/0525; H01M 10/0567; H01M 10/0568

(52) U.S. Cl. CPC H01M 10/0569; H01M 4/525; H01M 4/583; H01M 10/0525; H01M 10/0567; H01M 10/0568; H01M 2004/027; H01M 2004/028; H01M 2300/0034; H01M 2300/004

(57) ABSTRACT

An electrolyte for a rechargeable lithium battery and a rechargeable lithium battery including the same are provided. The electrolyte for a rechargeable lithium battery may include a non-aqueous organic solvent, a lithium salt, and an additive. The non-aqueous organic solvent may include a first compound represented by Formula 1. The additive may include a second compound represented by Formula 2. Detailed description on Formula 1 and Formula 2 above are as described in the specification.

### CROSS-REFERENCE TO RELATED APPLICATIONS

The present application claims priority to and the benefit of Korean Patent Application No. 10-2024-0131854, filed on Sep. 27, 2024, the entire content of which is hereby incorporated by reference.

### BACKGROUND

### (a) Field

The present disclosure herein relates to an electrolyte for a rechargeable lithium battery, and a rechargeable lithium battery including the same.

### (b) Description of the Related Art

Recently, with the rapid spread of battery-using (e.g., battery-powered) electronic devices, such as mobile phones, laptop computers, and/or electric vehicles, demand for rechargeable batteries with high energy density and high capacity has rapidly increased. Accordingly, research and development have been actively conducted to improve performance of the rechargeable batteries, such as rechargeable lithium batteries.

A rechargeable lithium battery includes a positive electrode and a negative electrode, each containing an active material capable of intercalation and deintercalation of lithium ions, and an electrolyte. Electrical energy is produced by oxidation and reduction reactions if (e.g., when) lithium ions are intercalated into and deintercalated from the positive electrode and the negative electrode.

The electrolyte for the rechargeable lithium battery includes a lithium salt dissolved in a non-aqueous organic solvent. The rechargeable lithium battery has battery characteristics (e.g., generates electricity) through complex reactions between the positive electrode and the electrolyte, the negative electrode and the electrolyte, and/or the like. Therefore, utilizing an appropriate or suitable electrolyte is one of the important variables that can improve performance of the rechargeable lithium battery.

### SUMMARY

An aspect according to one or more embodiments of the present disclosure is directed toward an electrolyte for a rechargeable lithium battery capable of enhancing (e.g., improving) lifespan characteristics and stability of the battery.

An aspect according to one or more embodiments of the present disclosure is directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments, an electrolyte for a rechargeable lithium battery includes a non-aqueous organic solvent, a lithium salt, and an additive.

The non-aqueous organic solvent may include a first compound represented by Formula 1. The additive may include a second compound represented by Formula 2. Descriptions of Formulae 1 and 2 are provided in more detail later.

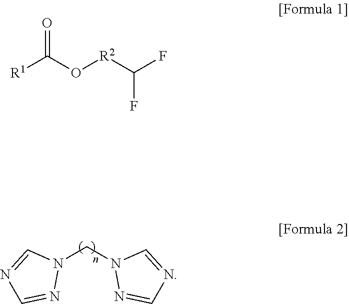

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure, and, together with the description, serve to explain principles of the present disclosure. In the drawings:

FIG. 1 is a simplified conceptual diagram illustrating a rechargeable lithium battery according to one or more embodiments of the present disclosure;

FIG. 2 is a schematic illustration of a cylindrical battery according to one or more embodiments of the present disclosure;

FIG. 3 is a schematic illustration of a prismatic battery according to one or more embodiments of the present disclosure;

FIG. 4 is a schematic illustration of a pouch-type (kind) battery according to one or more embodiments of the present disclosure; and

FIG. 5 is a schematic illustration of a pouch-type (kind) battery according to one or more embodiments of the present disclosure.

### DETAILED DESCRIPTION

In order to fully understand the configuration and effect of the present disclosure, embodiments of the present disclosure will be described in more detail with reference to the accompanying drawings. The present disclosure may, however, be embodied in one or more suitable forms and should not be construed as limited to the embodiments set forth herein, and one or more suitable changes and modifications can be made. Rather, these embodiments are provided so that this disclosure will be thorough and complete, and will fully convey the scope of the present disclosure to those skilled in the art to which the present disclosure pertains.

In this specification, it will be understood that, if (e.g., when) an element is referred to as being “on” another element, the element may be directly on the other element or intervening elements may be present therebetween. In the drawings, thicknesses of components may be exaggerated for effectively explaining the technical contents. Like reference numerals or symbols refer to like elements throughout, and duplicative descriptions thereof may not be provided in the specification.

The singular forms are intended to include the plural forms as well, unless the context clearly indicates otherwise. In addition, unless otherwise specially noted, the phrases “A or B” and “A and/or B” may indicate the inclusion of “A but not B, B but not A, or A and B”. The terms “comprises/includes” and/or “comprising/including” used in this description do not exclude the presence or addition of one or more other components.

In this specification, the term “combination thereof” may refer to a mixture, a stack, a composite, a copolymer, an alloy, a blend, and/or a reaction product of components.

Unless otherwise defined in this specification, a particle diameter may be an average particle diameter. Also, the particle diameter refers to an average particle diameter (D50) which refers to a diameter of particles at a cumulative volume of about 50 vol % in a particle size distribution. The average particle diameter (D50) may be measured by any suitable method (e.g., known to those skilled in the art), for example, may be measured by a particle size analyzer, or may be measured using a transmission electron microscope (TEM) image or a scanning electron microscope (SEM) image. In one or more embodiments, the average particle diameter is measured by a measuring device using dynamic light-scattering, wherein the number of particles is counted for each particle size range by performing data analysis, and an average particle diameter (D50) value may then be calculated based on the obtained data. Also, the average particle diameter may be measured using a laser diffraction method. When measured by the laser diffraction method, after dispersing particles to be measured in a dispersion medium, the dispersion medium is introduced into a commercial laser diffraction particle size measurement instrument (e.g., Microtrac MT 3000™) and irradiated with ultrasonic waves of about 28 kHz at a power output of about 60 W, and the average particle diameter (D50) based on about 50 vol % of the particle size distribution in the measurement instrument may then be calculated. In the present specification, when particles are spherical, “diameter” or “size” indicates a particle diameter, and when the particles are non-spherical, the “diameter” or “size” indicates a major axis length.

In this specification, unless defined otherwise, the term “substitution” refers to that at least one hydrogen of a substituent or a compound is substituted with deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or a (e.g., any suitable) combination thereof.

In one or more embodiments, the term “substitution” may refer to that at least one hydrogen of a substituent or a compound is substituted with deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substitution” may refer to that at least one hydrogen of a substituent or a compound is substituted with deuterium, a halogen group, a C1 to C20 alkyl group, a C6 to C30 aryl group, a C1 to C10 fluoroalkyl group, or a cyano group. In one or more embodiments, the term “substitution” may refer to that at least one hydrogen of a substituent or a compound is substituted with deuterium, a halogen group, a C1 to C5 alkyl group, a C6 to C18 aryl group, a C1 to C5 fluoroalkyl group, or a cyano group. For example, the term “substitution” may refer to that at least one hydrogen of a substituent or a compound is substituted with deuterium, a cyano group, a halogen group, a methyl group, an ethyl group, a propyl group, a butyl group, a phenyl group, a biphenyl group, a terphenyl group, a trifluoromethyl group, or a naphthyl group.

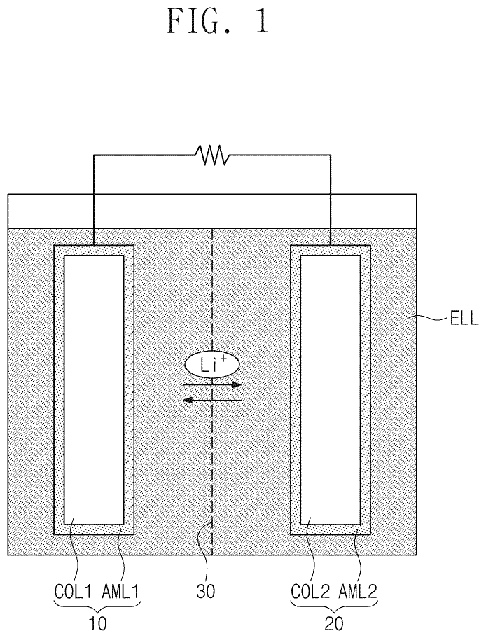

FIG. 1 is a simplified conceptual diagram illustrating a rechargeable lithium battery according to one or more embodiments of the present disclosure. Referring to FIG. 1, the rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other with the separator 30 therebetween. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium for transferring lithium ions between the positive electrode 10 and the negative electrode 20. In the electrolyte ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and may further include a binder and/or a conductive material (e.g., an electrically conductive material).

An amount of the positive electrode active material in the positive electrode active material layer AML1 may be about 90 wt % to about 99.5 wt % based on 100 wt % of the positive electrode active material layer AML1. An amount of each of the binder and the conductive material may be about 0.5 wt % to about 5 wt % based on 100 wt % of the positive electrode active material layer AML1.

The binder serves to attach the positive electrode active material particles well or suitably to each other and also to attach the positive electrode active material well or suitably to the current collector COL1. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Examples of the conductive material may include a carbon-based material such as natural graphite, artificial graphite, carbon black, acetylene black, Ketjen black, a carbon fiber, a carbon nanofiber, and/or carbon nanotube; a metal-based material containing copper, nickel, aluminum, silver, and/or the like, in a form of a metal powder or a metal fiber; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (lithiated intercalation compound) that is capable of reversibly intercalating and deintercalating lithium ions. For example, at least one of a composite oxide of lithium and a metal selected from among cobalt, manganese, nickel, and/or one or more (e.g., any suitable) combinations thereof may be used.

The composite oxide may be a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, and/or a (e.g., any suitable) combination thereof.

As an example, the compounds represented by any one of (e.g., selected from among) the following chemical formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); and LiₐFePO₄ (0.90≤a≤1.8).

In the above formulas, A is Ni, Co, Mn, and/or a (e.g., any suitable) combination thereof; X is Al, Ni, Co, Mn, Cr, Fe, Mg, Sr, V, a rare earth element and/or a (e.g., any suitable) combination thereof; D is O, F, S, P, and/or a (e.g., any suitable) combination thereof; G is Al, Cr, Mn, Fe, Mg, La, Ce, Sr, V, and/or a (e.g., any suitable) combination thereof; and L¹ is Mn, Al, and/or a (e.g., any suitable) combination thereof.

The positive electrode active material may be, for example, a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of all the metals excluding lithium in the lithium transition metal composite oxide. The high-nickel-based positive electrode active material may be capable of realizing high capacity and can be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well or suitably to each other and also to attach the negative electrode active material well or suitably to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is used as the negative electrode binder, a cellulose-based compound capable of imparting (e.g., influencing) viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous (e.g., in the form of a fiber). For example, the dry binder may be polytetrafluoroethylene, polyvinylidene fluoride, a polyvinylidene fluoride-hexafluoropropylene copolymer, polyethylene oxide, and/or a (e.g., any suitable) combination thereof.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Non-limiting examples thereof may include a carbon-based material such as natural graphite, artificial graphite, carbon black, acetylene black, Ketjen black, a carbon fiber, a carbon nanofiber, and/or a carbon nanotube; a metal-based material including copper, nickel, aluminum, silver, and/or the like, in a form of a metal powder or a metal fiber; a conductive polymer such as a polyphenylene derivative; and/or a (e.g., any suitable) mixture thereof.

The negative current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example. crystalline carbon, amorphous carbon and/or a (e.g., any suitable) combination thereof. The crystalline carbon may be graphite such as non-shaped (e.g., have an irregular shape), sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof), and/or a (e.g., any suitable) combination thereof. The Sn-based negative electrode active material may include Sn, SnOₓ (0<x≤2, e.g., SnO₂), a Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon applied (e.g., coated) onto the surface of the silicon particles. For example, the silicon-carbon composite may include a secondary particle (core) in which primary silicon particles (e.g., silicon primary particles) are assembled, and an amorphous carbon coating layer (shell) on the surface of the secondary particle. The amorphous carbon may also be between the primary silicon particles, and for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Separator 30

Depending on the type (kind) of the rechargeable lithium battery, the separator 30 may be present between the positive electrode 10 and the negative electrode 20. The separator 30 may include polyethylene, polypropylene, polyvinylidene fluoride, a multilayer film of two or more layers thereof, or a mixed multilayer film such as a polyethylene/polypropylene two-layer separator, a polyethylene/polypropylene/polyethylene three-layer separator, a polypropylene/polyethylene/polypropylene three-layer separator, and/or the like.

The separator 30 may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one polymer selected from among polyolefin, such as polyethylene and/or polypropylene, polyester, such as polyethylene terephthalate and/or polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or a copolymer or mixture of two or more thereof.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Electrolyte ELL

The electrolyte ELL for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may be a carbonate-based, ester-based, ether-based, ketone-based, or alcohol-based solvent, an aprotic solvent, or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, propyl propionate (PP), and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R—CN (wherein R is a C2 to C20 linear, branched, or cyclic hydrocarbon group, a double bond, an aromatic ring, or an ether bond), and/or the like; amides such as dimethylformamide; dioxolanes such as 1,3-dioxolane, 1,4-dioxolane, and/or the like; sulfolanes, and/or the like.

The non-aqueous organic solvents may be used alone or in combination of two or more.

In addition, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are each independently an integer of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB).

Hereinafter, an electrolyte for a rechargeable lithium battery according to one or more embodiments of the present disclosure will be described in more detail.

The electrolyte for a rechargeable lithium battery, according to one or more embodiments of the present disclosure, may include a non-aqueous organic solvent, a lithium salt, and an additive. The non-aqueous organic solvent may include a first compound represented by Formula 1 to be described in more detail later. The additive may include a second compound represented by Formula 2 to be described in more detail later.

The electrolyte may be prepared through a mixing process in which the lithium salt is dissolved in the non-aqueous organic solvent, and the additive is added. The mixing process of preparing the electrolyte may be appropriately or suitably selected from suitable ones in the field of preparing the electrolyte (e.g., known to those skilled in the art).

### Non-Aqueous Organic Solvent

The non-aqueous organic solvent may include a first compound represented by Formula 1. The first compound may be a difluoro ester-based solvent.

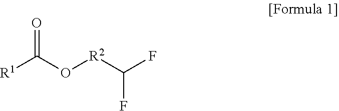

In Formula 1, R¹ may be a substituted or unsubstituted C1 to C6 alkyl group, or a substituted or unsubstituted C1 to C12 aryl group, and R² may be a direct bond or a C1 to C6 alkylene group.

In one or more embodiments, R¹ may be a substituted or unsubstituted C1 to C6 alkyl group, and R² may be a C1 to C6 alkylene group.

In one or more embodiments, the first compound may be represented by Formula 1-1.

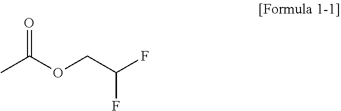

In one or more embodiments, an amount of the first compound may be about 50 vol % to about 85 vol % on the basis of the total volume (100 vol %) of the non-aqueous organic solvent. In one or more embodiments, the amount of the first compound may be about 60 vol % to about 85 vol %. In one or more embodiments, the amount of the first compound may be about 70 vol % to about 80 vol %.

The first compound may strengthen stability of a battery. The first compound may provide flame retardancy, and may contribute to stable formation of a solid electrolyte interphase (SEI) layer. The first compound includes fluorine, which has high electronegativity, and may thus have high oxidation stability, thereby preventing or reducing oxidation of the electrolyte. For example, in an unstable condition of high temperature and/or high voltage, oxidative decomposition of the electrolyte may be effectively suppressed or reduced (e.g., due to the inclusion of the first compound in the non-aqueous organic solvent), and ignition may thus be prevented or reduced. In addition, the fluorine included in the first compound may be reduced on a surface of an electrode (e.g., may react with the electrode) to form lithium fluoride (LiF). Because lithium fluoride (LiF) is a stable material not easily decomposed by the external environment, chemical stability of an SEI layer may be strengthened.

While the first compound strengthens the battery stability as described above, the first compound may (potentially) have a problem of decreasing the battery performance (if the first compound is included at an excessive amount). If (e.g., when) the amount of the first compound is excessive, viscosity of the electrolyte may increase, and the SEI layer (e.g., the LiF layer formed by reduction of the first compound on the surface of the electrode) may become excessively (or substantially) thick. Accordingly, movement of lithium ions may be hindered, and resistance inside the battery may increase. In the electrolyte according to embodiments of the present disclosure, this problem may be minimized or reduced by controlling the amount of the first compound to the above described optimal or suitable range. In addition, by using a second compound, to be described in more detail later, together with the first compound, the battery performance may be further improved, and the problem of poor performance, caused by the first compound, may be effectively solved.

In one or more embodiments, the non-aqueous organic solvent may further include a carbonate-based solvent. An amount of the carbonate-based solvent may be about 15 vol % to about 50 vol % on the basis of the total volume (100 vol %) of the non-aqueous organic solvent. In one or more embodiments, the amount may be about 20 vol % to about 40 vol %. In one or more embodiments, the amount may be about 20 vol % to about 30 vol %.

The volume ratio of the first compound and the carbonate-based solvent may be about 50:50 to about 75:25. In one or more embodiments, the volume ratio of the first compound and the carbonate-based solvent may be about 60:40 to about 75:25.

The carbonate-based solvent may improve fluidity (e.g., lower the viscosity) of the electrolyte, and therefore, if (e.g., when) used in combination with the first compound, the carbonate-based solvent may compensate for the shortcoming of the first compound (e.g., to thereby providing the electrolyte with a suitable viscosity). However, the carbonate-based solvent may have a tendency to be oxidized and decomposed at a high voltage of about 4.45 V or higher to form a resistance layer on a surface of an electrode. Therefore, if (e.g., when) the amount of the carbonate-based solvent is excessive, problems of increased battery resistance, gas generation, depletion of the electrolyte, and/or the like may be caused. For example, due to substantially continuous cycles of charging and discharging, a positive electrode charging potential may increase and further intensify the above-described problems. If (e.g., when) the amount of the carbonate-based solvent is maintained within the above described ranges, the problems of the carbonate-based solvent may be minimized or reduced, and the shortcoming of the first compound may be effectively compensated for.

In one or more embodiments, the non-aqueous organic solvent may include ethylene carbonate (EC), propylene carbonate (PC), and the first compound. However, the above-described embodiment is only one or more embodiments of one or more suitable carbonate-based solvents, and the present disclosure is not limited thereto.

### Lithium Salt

In one or more embodiments, the lithium salt may be one, two, or more selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, lithium bis(fluorosulfonyl)imide (Li(FSO₂)₂N, LiFSI), LiC₄F₉SO₃, LiN(CₓF₂ₓ₊₁SO₂) (C_{y}F_{2y+1}SO₂) (where, x and y are each independently an integer of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato) borate (LiBOB).

In one or more embodiments, the lithium salt may include LiPF₆.

In one or more embodiments, the lithium salt may have a concentration of about 0.1 M to about 2.0 M. For example, the concentration of the lithium salt may be about 0.5 M or greater, or about 0.8 M or greater. The concentration of the lithium salt may be about 2.0 M or less, about 1.7 M or less, or about 1.5 M or less. When the concentration falls within the above ranges, conductivity and viscosity of the electrolyte may be appropriately or suitably maintained.

### Additive

The additive according to embodiments of the present disclosure may include a second compound represented by Formula 2.

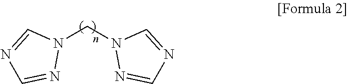 [SMILES: c1ncn(Cn2cncn2)n1]

In Formula 2, n may be an integer of 1 to 8.

In one or more embodiments, in Formula 2, n may be an integer of 4 to 7.

In one or more embodiments, the second compound may be one of compounds represented by Formula 2-1 to Formula 2-3.

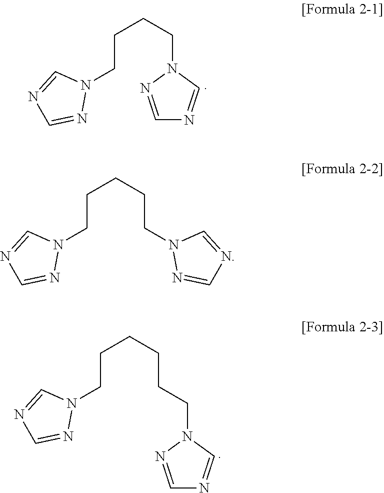 [SMILES: c1ncn(CCCCn2cncn2)n1 ; c1ncn(CCCCCn2cncn2)n1 ; c1ncn(CCCCCCn2cncn2)n1]

An amount of the second compound may be about 0.1 wt % to about 10 wt % on the basis of the total weight of the electrolyte for the rechargeable lithium battery. In one or more embodiments, the amount may be about 0.1 wt % to about 5 wt %. In one or more embodiments, the amount may be about 0.1 wt % to about 1.5 wt %. The amount of the second compound refers to a relative weight of the second compound on the basis of 100 wt % of the total electrolyte (lithium salt+non-aqueous organic solvent) excluding the additive.

The second compound may be a dimer in which two triazoles are linked by an alkylene linking group. The triazoles may remove HF caused by deterioration of the positive electrode (e.g., through reaction with the first compound), and stabilize interaction between the electrolyte and the electrode. Accordingly, performance of a battery may be improved. For example, the two triazoles are adjacently positioned to perform functions cooperatively. While one triazole is binding to a target (for example, HF), the other triazole may perform an additional interaction, so that the removal of HF and stabilization of interaction may be more effectively performed.

As the alkylene linking group, a C1 to C8 alkylene linking group having no functional group (e.g., no reactive groups) may be used. In one or more embodiments, the alkylene linking group may have about 4 to about 7 carbon atoms. If (e.g., when) the number of carbon atoms in the alkylene linking group is too small, the two triazoles may be positioned too close to each other, so that steric hindrance may occur. Therefore, only one triazole may participate in the reaction to function as a monomer. If (e.g., when) the number of carbon atoms in the alkylene linking group is too large, the molecular structure may become too fluid, so that a desired or suitable interaction may not occur.

The second compound may be used in combination with the first compound according to embodiments of the present disclosure to exert a synergistic effect. While the first compound strengthens the battery stability as described above, the first compound may (potentially) have a problem of decreasing performance of the battery (e.g., due to the formation of a thick SEI layer). To improve the battery performance, the second compound may compensate for the performance degradation caused by the first compound. If another type (kind) of ester-based solvent is used instead of the first compound, a desired or suitable improvement effect of stability and performance may not be achieved.

### Rechargeable Lithium Battery

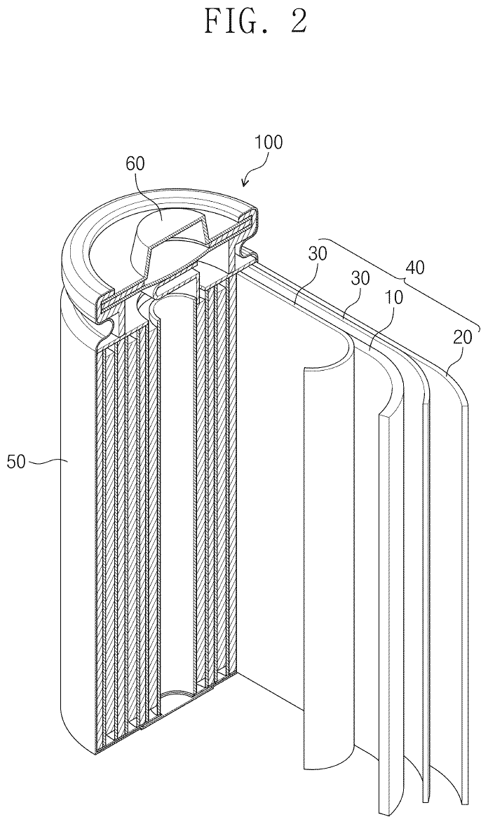

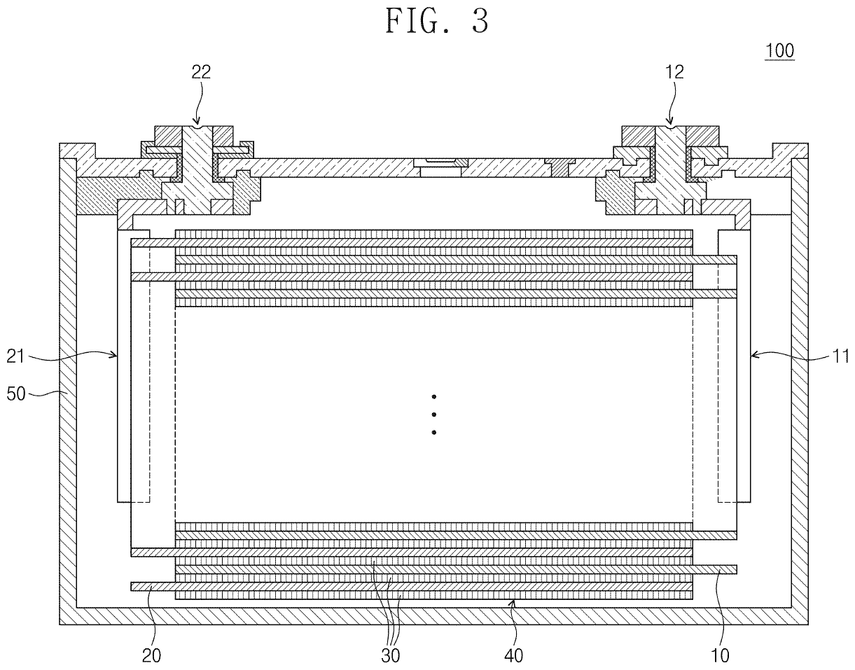

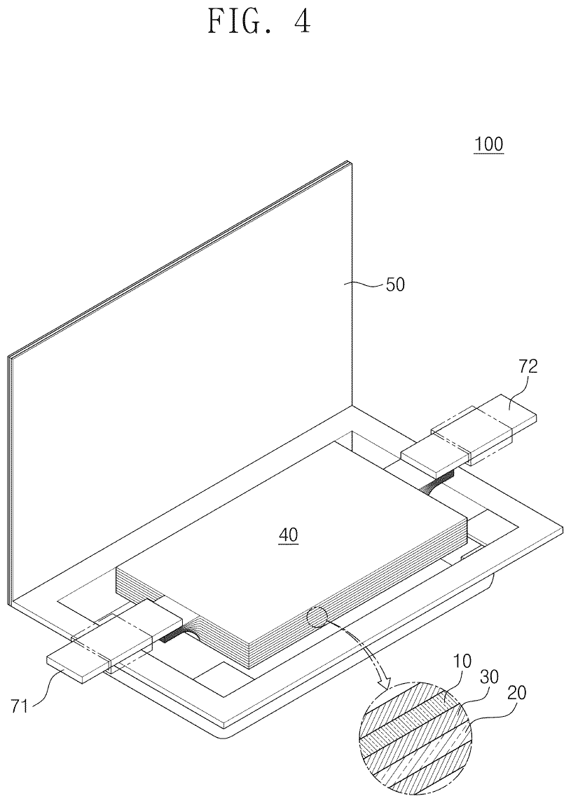

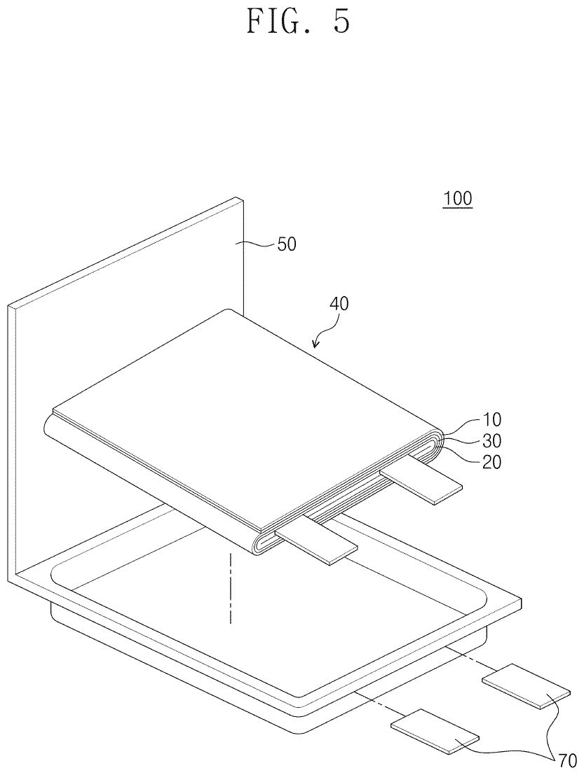

The rechargeable lithium battery may be classified into cylindrical, prismatic, pouch-type (kind), coin-type (kind) batteries, and/or the like depending on the shape. FIGS. 2 to 5 are schematic views each illustrating a rechargeable lithium battery according to one or more embodiments, FIG. 2 shows a cylindrical battery, FIG. 3 shows a prismatic battery, and FIGS. 4 and 5 show pouch-type (kind) batteries. Referring to FIGS. 2 to 5, the rechargeable lithium battery 100 may include an electrode assembly 40 having a separator 30 arranged between a positive electrode 10 and a negative electrode 20, and a case 50 in which the electrode assembly 40 is included. The positive electrode 10, the negative electrode 20, and the separator 30 may be impregnated with an electrolyte. The rechargeable lithium battery 100 may include a sealing member 60 sealing the case 50, as shown in FIG. 2. Also, in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, which may be, for example, a positive electrode tab 71 and a negative electrode tab 72 serving as an electrical path for inducing the current formed in the electrode assembly 40 to the outside.

The rechargeable lithium battery according to one or more embodiments of the present disclosure may be applied to automobiles, mobile phones, and/or one or more suitable types (kinds) of electric devices, and the present disclosure is not limited thereto.

The rechargeable lithium battery according to one or more embodiments of the present disclosure may include a positive electrode including a positive electrode active material; a negative electrode including a negative electrode active material; and the electrolyte for a rechargeable lithium battery described above.

In one or more embodiments, the positive electrode active material may include a lithium composite oxide represented by Formula 3:

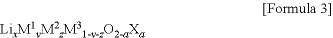

0.5≤x≤1.8, 0≤a≤0.05, 0<y≤1, 0≤z≤1, and 0<y+z≤1 may be satisfied,
M¹, M² and M³ may each independently include (e.g., may be) one or more elements selected from among metals such as Ni, Co, Mn, Al, B, Ba, Ca, Ce, Cr, Fe, Mo, Nb, Si, Sr, Mg, Ti, V, W, Zr, La, and/or a (e.g., any suitable) combination thereof,
X may include (e.g., may be) one or more elements selected from among F, S, P, and Cl.

In one or more embodiments, the positive electrode active material may include a lithium cobalt-based oxide having a layered crystal structure.

In one or more embodiments, the negative electrode active material may be a carbon-based negative electrode active material, a Si-based negative electrode active material, a Sn-based negative electrode active material, and/or a (e.g., any suitable) combination thereof.

In one or more embodiments, the negative electrode active material may include graphite.

Due to the effect of stability improvement of the non-aqueous organic solvent and the effect of performance improvement of the additive in the electrolyte, excellent or suitable performance of the rechargeable lithium battery may be maintained without occurrence of ignition even at a high voltage. The high voltage may be about 4.0 V or higher, 4.4 V or higher, or 4.5 V or higher.

### EXAMPLE AND COMPARATIVE EXAMPLE

Hereinafter, examples and comparative examples of the present disclosure are described. However, the following examples are only embodiments of the present disclosure, and the present disclosure is not limited to the following examples.

### Example 1

### (1) Preparation of Electrolyte

LiPF₆ was dissolved at about 1.3 M in a non-aqueous organic solvent, in which a first compound and a carbonate-based solvent were mixed in a volume ratio shown in Table 1. A second compound was added and then mixed to prepare an electrolyte. The electrolytes according to examples and comparative examples were prepared according to the compositions listed in Table 1.

As the first compound, a compound represented by Formula 1-1 was used, and as the second compound, a compound represented by Formula 2-2 was used.

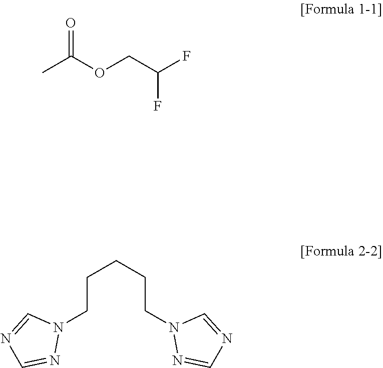

TABLE 1

| | Non-aqueous organic solvent | | | | |
|---|---|---|---|---|---|
| | Ethylene | Propylene | Propyl | | Additive |
| | carbonate | carbonate | propionate | First | Second |
| | (EC) | (PC) | (PP) | compound | compound |
| | (vol %) | (vol %) | (vol %) | (vol %) | (wt %) |
| Comparative | 10 | 15 | 75 | | |
| Example 1 | | | | | |
| Comparative | 10 | 15 | | 75 | |
| Example 2 | | | | | |
| Example 1 | 10 | 15 | | 75 | 1 |
| Example 2 | 10 | 15 | | 75 | 0.1 |
| Example 3 | 10 | 15 | | 75 | 0.2 |
| Example 4 | 10 | 15 | | 75 | 0.5 |
| Example 5 | 10 | 15 | | 75 | 2 |
| Example 6 | 10 | 15 | | 75 | 5 |

### (2) Preparation of Rechargeable Lithium Battery

About 97 wt % of LiCoO₂ (LCO) as a positive electrode active material, about 0.5 wt % of artificial graphite powder as a conductive material, about 0.8 wt % of carbon black (Ketjen black), about 0.2 wt % of acrylonitrile rubber, and about 1.5 wt % of polyvinylidene fluoride (PVdF) were mixed and added to N-methyl-2-pyrrolidone (NMP), and then agitated for about 30 minutes using a mechanical agitator to prepare a positive electrode active material slurry. A doctor blade was used to apply the slurry in a thickness of about 60 μm onto an aluminum current collector having a thickness of about 20 μm, the applied slurry was dried in a hot-air drier at about 100° C. for about 0.5 hours, then dried again for about 4 hours at about 120° C. in a vacuum condition, and roll-pressed to prepare a positive electrode.

About 98 wt % of a negative electrode active material in which graphite and a Si composite were mixed in a weight ratio of about 95.8:4.2, about 1 wt % of a styrene-butadiene rubber (SBR), and about 1 wt % of carboxymethyl cellulose (CMC) were mixed and then added to distilled water, and agitated for about 60 minutes using a mechanical agitator to prepare a negative electrode active material slurry. A doctor blade was used to apply the slurry in a thickness of about 60 μm onto a copper current collector having a thickness of about 10 μm, the applied slurry was dried in a hot-air drier at about 100° C. for about 0.5 hours, then dried again for about 4 hours at about 120° C. in a vacuum condition, and roll-pressed to prepare a negative electrode.

The positive electrode, the negative electrode, and a polyethylene separator having a thickness of about 16 μm were assembled to prepare an electrode assembly, and the electrolyte was injected to prepare a rechargeable lithium battery.

### Evaluation Example 1: Evaluation on Flame Retardant Characteristics

For each of the rechargeable lithium batteries prepared according to the examples and comparative examples, Miniflash FP Vision of Grabner Instruments was used to measure a flash point. A sample was placed in a sealed container (a closed cup), and the sample inside the container was slowly heated. Gas inside the container was exposed (e.g., to flames) at regular intervals, flames were applied to the gas, and the temperature at which the gas ignited instantaneously was recorded. The results were listed in Table 2.

### Evaluation Example 2: Evaluation on High-Temperature Lifespan Characteristics

A cycle of charging and discharging was performed 400 times on the rechargeable lithium batteries, prepared according to each of the examples and comparative examples, under conditions of charging with about 2.0 C at about 45° C. (CC/CV, 4.53 V 0.05 C cut-off)/discharging with about 1.0 C (CC, 3.0 V cut-off), and then the characteristic values of the batteries were measured. The capacity retention rate was calculated according to Equation 1. The results were listed in Table 2.

$$[ Equation 1 ]$$

$$Capacity retention rate ( \% ) = ( discharge capacity after 400 cycles / initial discharge capacity ) \times 100$$

### Evaluation Example 3: Evaluation on High-Temperature Storage Characteristics

The rechargeable lithium batteries, prepared according to the examples and comparative examples, were charged under conditions of 45° C., 0.5 C, 4.53 V, with a 0.05 C cut-off. The battery thicknesses, i.e., initial battery thickness immediately after the charging, were measured. The batteries were then left to rest at about 60° C. for 28 days, and the thicknesses of the batteries after the rest were measured. Each of the thicknesses was measured using a press-type (kind) thickness meter of Mitutoyo, in which the pouch cell (to be measured) was positioned between compression plates, and then compressed with a weight of about 300 g to measure the thickness. The thickness increase rate was calculated according to Equation 2. The results were listed in Table 2.

$$[ Equation 2 ]$$

$$Thickness increase rate ( \% ) = ( thickness after 28 days / initial thickness ) \times 100$$

TABLE 2

| | | Lifespan | | | |
|---|---|---|---|---|---|
| | Flame | evaluation | Storage evaluation | | |
| | retardancy | Capacity | | Thickness | increase |
| | evaluation | retention | Initial | after | rate |
| | Flash point | rate | thickness | 28 days | Thickness |
| | (° C.) | (%) | (mm) | (mm) | (%) |
| Comparative | 29 | 67.1 | 5.449 | 6.531 | 120% |
| Example | | | | | |
| 1 | | | | | |
| Comparative | Nonflammable | 63.3 | 5.423 | 6.634 | 122% |
| Example | | | | | |
| 12 | | | | | |
| Example 1 | Nonflammable | 72.9 | 5.425 | 6.301 | 116% |
| Example 2 | Nonflammable | 63.8 | 5.422 | 6.482 | 120% |
| Example 3 | Nonflammable | 65.3 | 5.424 | 6.396 | 118% |
| Example 4 | Nonflammable | 68.9 | 5.426 | 6.339 | 117% |
| Example 5 | Nonflammable | 67.2 | 5.429 | 6.386 | 118% |
| Example 6 | Nonflammable | 62.4 | 5.427 | 6.368 | 117% |

Referring to Table 1 and Table 2, each of the examples according to the present disclosure demonstrated excellent or suitable flame retardant characteristics, lifespan characteristics and storage characteristics at high temperature, compared with each of the comparative examples. For example, it can be seen that the electrolyte and the battery according to embodiments of the present disclosure had both high stability and excellent or suitable battery performance at the same time (e.g., simultaneously or concurrently).

An electrolyte for a rechargeable lithium battery according to one or more embodiments of the present disclosure may improve lifespan characteristics and stability of a battery. A rechargeable lithium battery according to one or more embodiments of the present disclosure may have excellent or suitable lifespan characteristics and stability. The innovative electrolyte composition not only ensures high energy density and capacity but also provides enhanced safety features, making the battery highly suitable for use in various electronic devices and/or electric vehicles.

For example, according to embodiments of the present disclosure, an electrolyte for a rechargeable lithium battery includes a non-aqueous organic solvent; a lithium salt; and an additive, wherein the non-aqueous organic solvent includes a first compound represented by Formula 1, and the additive comprises a second compound represented by Formula 2. By including both the first compound and the second compound, a synergistic effect may be achieved and the battery may have both excellent stability and lifespan, even at high temperatures. For example, by including the first compound represented by Formula 1 with two fluorine atoms, the battery stability may be improved and a stable SEI layer may be formed on the electrodes. Furthermore, by including the additive represented by Formula 2 with two triazole groups, HF caused by deterioration of the positive electrode (e.g., through reaction with the first compound) may be removed and the interaction between the electrolyte and the electrode may be stabilized. Therefore, the battery flame retardance, storage stability and performance may all be improved.

The electrolyte according to embodiments of the present disclosure may further include a carbonate-based solvent in the non-aqueous organic solvent, which may further improve the viscosity of the electrolyte to a suitable range, further improving the battery performance.

The use of “may” when describing embodiments of the inventive concept refers to “one or more embodiments of the inventive concept.”

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively.

Descriptions of features or aspects within each embodiment should typically be considered as available for other similar features or aspects in other embodiments.

A battery forming or manufacturing system, a battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

Although one or more embodiments of the present disclosure have been described with reference to the accompanying drawings, it is understood that the present disclosure should not be limited to these embodiments but one or more suitable changes and modifications can be made within the spirit and scope of the appended claims and equivalents thereof, the detailed description of the present invention, and the accompanying drawings, and this also falls within the scope of the present disclosure.

What is claimed is:

1. An electrolyte comprising:
a non-aqueous organic solvent;
a lithium salt; and
an additive,
wherein the non-aqueous organic solvent comprises a first compound represented by Formula 1, and
the additive comprises a second compound represented by Formula 2: 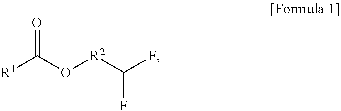
wherein, in Formula 1,
R¹ is a substituted or unsubstituted C1 to C6 alkyl group, or a substituted or unsubstituted C1 to C12 aryl group, and
R² is a direct bond or a C1 to C6 alkylene group, and 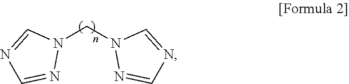
wherein, in Formula 2, n is an integer of 1 to 8, and
wherein the electrolyte is an electrolyte for a rechargeable lithium battery.

2. The electrolyte as claimed in claim 1, wherein
R¹ is a substituted or unsubstituted C1 to C6 alkyl group, and
R² is a C1 to C6 alkylene group.

3. The electrolyte as claimed in claim 1, wherein the first compound is represented by Formula 1-1:

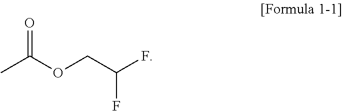

4. The electrolyte as claimed in claim 1, wherein the first compound is about 50 vol % to about 85 vol % in amount based on a total volume of the non-aqueous organic solvent.

5. The electrolyte as claimed in claim 1, wherein
the non-aqueous organic solvent further comprises a carbonate-based solvent, and
the carbonate-based solvent is about 15 vol % to about 50 vol % based on a total volume of the non-aqueous organic solvent.

6. The electrolyte as claimed in claim 1, wherein
the non-aqueous organic solvent further comprises a carbonate-based solvent, and
a volume ratio of the first compound and the carbonate-based solvent is about 50:50 to about 75:25.

7. The electrolyte as claimed in claim 1, wherein the non-aqueous organic solvent comprises ethylene carbonate (EC), propylene carbonate (PC), and the first compound.

8. The electrolyte as claimed in claim 1, wherein, in Formula 2, n is an integer of 4 to 7.

9. The electrolyte as claimed in claim 1, wherein the second compound is one of compounds represented by Formula 2-1 to Formula 2-3:

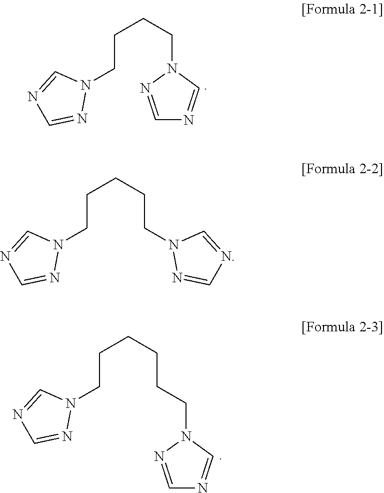 [SMILES: c1ncn(CCCCn2cncn2)n1 ; c1ncn(CCCCCn2cncn2)n1 ; c1ncn(CCCCCCn2cncn2)n1]

10. The electrolyte as claimed in claim 1, wherein the second compound is about 0.1 wt % to about 10 wt % based on a total weight of the non-aqueous organic solvent and the lithium salt.

11. The electrolyte as claimed in claim 1, wherein the second compound is about 0.1 wt % to about 5 wt % based on a total weight of the non-aqueous organic solvent and the lithium salt.

12. The electrolyte as claimed in claim 1, wherein the lithium salt is at least one selected from among LiPF₆; LiBF₄; LiSbF₆; LiAsF₆; LiClO₄; LiAlO₂; LiAlCl₄; LiPO₂F₂; LiCl; LiI; LiN(SO₃C₂F₅)₂; lithium bis(fluorosulfonyl)imide (Li(FSO₂)₂N; LiFSI); LiC₄F₉SO₃; LiN(CₓF₂ₓ₊₁SO₂)(C_{y}F_{2y+1}SO₂), where x and y are each independently an integer of 1 to 20; lithium trifluoromethane sulfonate; lithium tetrafluoroethanesulfonate; lithium difluoro (oxalato) borate (LiDFOB); lithium difluorobis(oxalato)phosphate (LiDFBOP); and lithium bis(oxalato) borate (LiBOB).

13. The electrolyte as claimed in claim 1, wherein the lithium salt comprises LiPF₆.

14. The electrolyte as claimed in claim 1, wherein a concentration of the lithium salt is about 0.1 M to about 2.0 M.

15. A rechargeable lithium battery comprising:
a positive electrode comprising a positive electrode active material;
a negative electrode comprising a negative electrode active material; and
the electrolyte as claimed in claim 1.

16. The rechargeable lithium battery as claimed in claim 15, wherein the positive electrode active material comprises a lithium composite oxide represented by Formula 3: 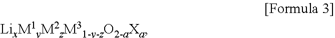
and
wherein, 0.5≤x≤1.8, 0≤a≤0.05, 0<y≤1, 0≤z≤1, and 0<y+z≤1,
each of M¹, M², and M³, independently, comprises one or more elements selected from among Ni, Co, Mn, Al, B, Ba, Ca, Ce, Cr, Fe, Mo, Nb, Si, Sr, Mg, Ti, V, W, Zr, La, and a combination thereof, and
X comprises one or more elements selected from among F, S, P, and Cl.

17. The rechargeable lithium battery as claimed in claim 15, wherein the positive electrode active material comprises a lithium cobalt-based oxide having a layered crystal structure.

18. The rechargeable lithium battery as claimed in claim 15, wherein the negative electrode active material comprises a carbon-based negative electrode active material, a Si-based negative electrode active material, a Sn-based negative electrode active material, or a combination thereof.

19. The rechargeable lithium battery as claimed in claim 15, wherein the negative electrode active material comprises graphite.

20. The rechargeable lithium battery as claimed in claim 15, wherein the rechargeable lithium battery is configured to operate even at a voltage of about 4.5 V or higher.
